(19) United States
(12) Patent Application Publication
(10) Pub. No.: US 2018/0069790 A1
(43) Pub. Date: Mar. 8, 2018

(54) PACKET TRANSFER DEVICE AND PACKET TRANSFER METHOD

(71) Applicant: FUJITSU LIMITED, Kawasaki-shi (JP)

(72) Inventor: Yasuyuki Mitsumori, Kawasaki (JP)

(73) Assignee: FUJITSU LIMITED, Kawasaki-shi (JP)

(21) Appl. No.: 15/642,456

(22) Filed: Jul. 6, 2017

(30) Foreign Application Priority Data
Sep. 7, 2016 (JP) 2016-174887

(51) Int. Cl. H04L 12/741; H04L 12/851; H04L 12/853

(52) U.S. Cl. CPC H04L 45/74; H04L 47/2416; H04L 47/24

(57) ABSTRACT

A packet transfer device including: a first storage that stores a first priority packet; a second storage that stores a second priority packet having a lower priority than the first priority packet; a first reader that reads the first priority packet stored into the first storage before storing the first priority packet into the first storage is completed; and a second reader that reads the second priority packet stored into the second storage after storing the second priority packet stored into the second storage is completed.

### CROSS-REFERENCE TO RELATED APPLICATION

This application is based upon and claims the benefit of priority of the prior Japanese Patent Application No. 2016-174887, filed on Sep. 7, 2016, the entire contents of which are incorporated herein by reference.

### FIELD

A certain aspect of embodiments described herein relates to a packet transfer device and a packet transfer method.

### BACKGROUND

For example, a packet transfer device such as a layer 2 switch and a router statistically multiplexes multiple packets to transfer them to other device. To reduce a delay of a packet in transfer processing, the packet transfer device performs priority control of the packet based on a priority of each packet, for example (see e.g. Japanese Laid-open Patent Publication Nos. 2003-348141, 2006-94060 and 2009-239453).

### SUMMARY

According to an aspect of the present invention, there is provided a packet transfer device including: a first storage that stores a first priority packet; a second storage that stores a second priority packet having a lower priority than the first priority packet; a first reader that reads the first priority packet stored into the first storage before storing the first priority packet into the first storage is completed; and a second reader that reads the second priority packet stored into the second storage after storing the second priority packet stored into the second storage is completed.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a network system;

FIG. 2 is a configuration diagram illustrating an example of a packet transfer device;

FIG. 3 is a configuration diagram illustrating an example of a format of a packet;

FIG. 4 is a diagram illustrating an example of a delay time of the packet in the queue configuration of a comparative example;

FIG. 5 is a diagram illustrating another example of the delay time of the packet in the queue configuration of the comparative example;

FIG. 6 is a diagram illustrating an example of writing operation and reading operation of the packet in accordance with a cut-through system using a single queue;

FIG. 7 is a diagram illustrating an example of writing operation and reading operation of the packet in accordance with the cut-through system using a plurality of queues;

FIG. 8 is a configuration diagram illustrating queue configuration of the packet transfer device according to an embodiment;

FIG. 9 is a configuration diagram illustrating an example of a reception-side line interface unit;

FIG. 10 is a diagram illustrating an example of a filter table;

FIG. 11 is a configuration diagram illustrating an example of a transmission-side line interface unit;

FIG. 12 is a flowchart illustrating an example of the operation of the reception-side line interface unit;

FIG. 13 is a flowchart illustrating an example of determination processing of a storage queue; and

FIG. 14 is a flowchart illustrating an example of the operation of the transmission-side line interface unit.

### DESCRIPTION OF EMBODIMENTS

For example, packets are separately stored in queues (buffers) provided every priority, and the packet is preferentially read from a queue of a high priority and transferred. Therefore, a packet of voice data (hereinafter referred to as “a voice packet”) requiring a low delay is set as a high priority packet, so that it is possible to preferentially read the voice packet from the queue compared with other packets.

When the packet has a variable-length format such as an IP (Internet Protocol) packet or an Ethernet frame for example, packets of different lengths are stored into the respective queues. When a low priority packet having a long packet length stored into the queue of a low priority is being read for example, the high priority packet cannot be read regardless of the priority. Therefore, the high priority packet is in a waiting state and the delay increases. Accordingly, there is a problem that the delay does not reduce even when the packet is the high priority packet.

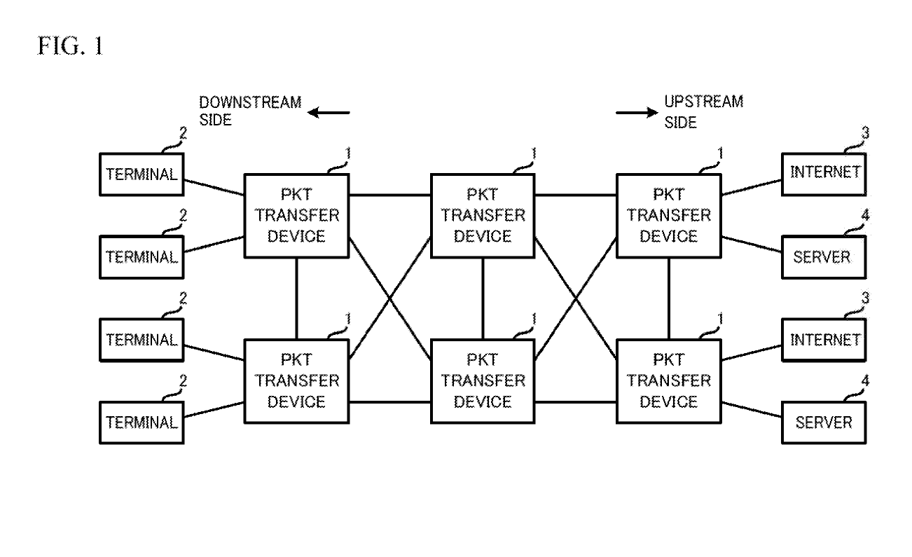

FIG. 1 is a configuration diagram illustrating an example of a network system. The network system includes a plurality of packet (PKT) transfer devices 1, a plurality of terminals 2 and a plurality of servers 4.

Each packet transfer device 1 is a layer 2 switch for example, and transfers a packet between downstream terminals 2, and upstream servers 4 and upstream internet 3 (or cloud servers). The packet transfer device 1 transfers the packet based on a destination address of the packet. Here, an Ethernet frame is considered as the packet, but the packet is not limited to this. The packet may be an IP (Internet Protocol) packet. The packet transfer devices 1 are connected to each other so as to configure a mesh-like network, but the network is not limited to this. The packet transfer devices 1 may be connected to each other so as to configure a ring-like network.

Each terminal 2 is a personal computer for example, and communicates with the internet 3 or the servers 4 via the packet transfer devices 1.

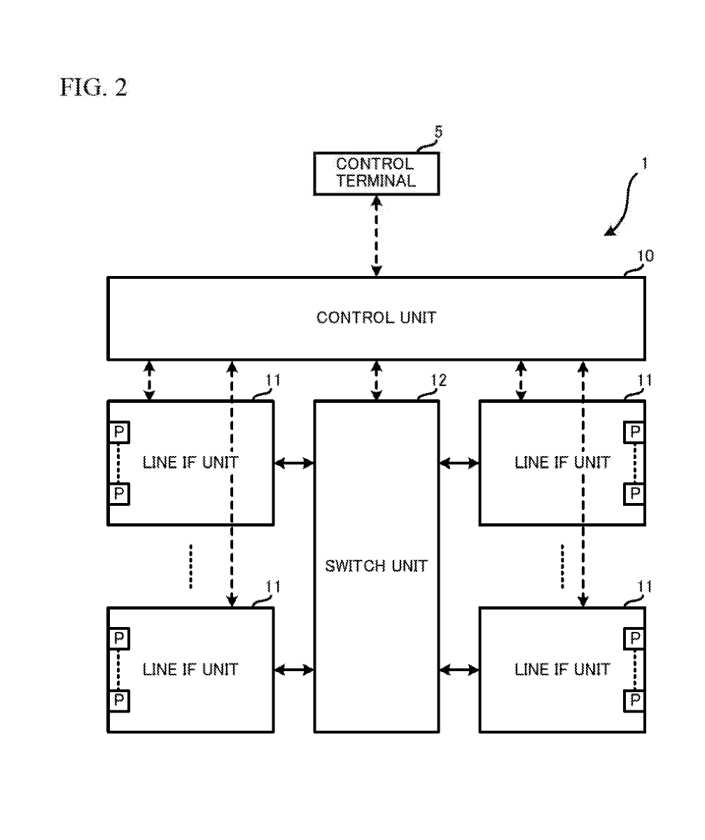

FIG. 2 is a configuration diagram illustrating an example of the packet transfer device 1. The packet transfer device 1 includes a control unit 10, a plurality of line interface units (line IF units) 11, and a switch unit 12.

Each of the line IF units 11, the switch unit 12 and the control unit 10 is configured by a circuit board of a card shape on which a plurality of electrical components are implemented, and is attachably and detechably implemented in a slot provided on a housing of the packet transfer device 1, for example. The line IF units 11, the switch unit 12 and the control unit 10 are connected to each other via wiring substrates and electrical connectors provided in the packet transfer device 1, and input and output data from/to each other via the wiring substrates. Here, the line IF units 11, the switch unit 12 and the control unit 10 are not limited to these, and may be formed as an integrated module.

Each line IF unit 11 includes a communication port P for each communication line, and transmits and receives the packet to/from other device via the communication port P. The line IF unit 11 performs reception processing of the packet input from the communication port P, and outputs the packet to the switch unit 12. The line IF unit 11 performs transmission processing of the packet input from the switch unit 12, and transmits the packet from the communication port P corresponding to the destination. Here, the line IF unit 11 is configured as a line IF circuit including a FPGA (Field Programmable Gate Array), a CPU (Central Processing Unit) or the like.

The switch unit 12 outputs the packet input from the line IF unit 11 to another line IF unit 11 corresponding to the destination. That is, the switch unit 12 exchanges the packet between the plurality of line IF units 11. Here, the switch unit 12 is configured as a switch circuit including the FPGA or the CPU circuit, as an example.

The control unit 10 performs various settings on each line IF unit 11 and the switch unit 12 by transmitting and receiving control signals to/from each line IF unit 11 and the switch unit 12 (see dotted lines), and collects an alarm and statistical information from each line IF unit 11 and the switch unit 12. Moreover, the control unit 10 is connected to a control terminal 5 such as personal computers, receives various settings from the control terminal 5, and outputs collected information to the control terminal 5. Here, the control unit 10 is configured as the switch circuit including the FPGA or the CPU circuit, as an example. Moreover, a network monitoring server may be used as substitute for the control terminal 5.

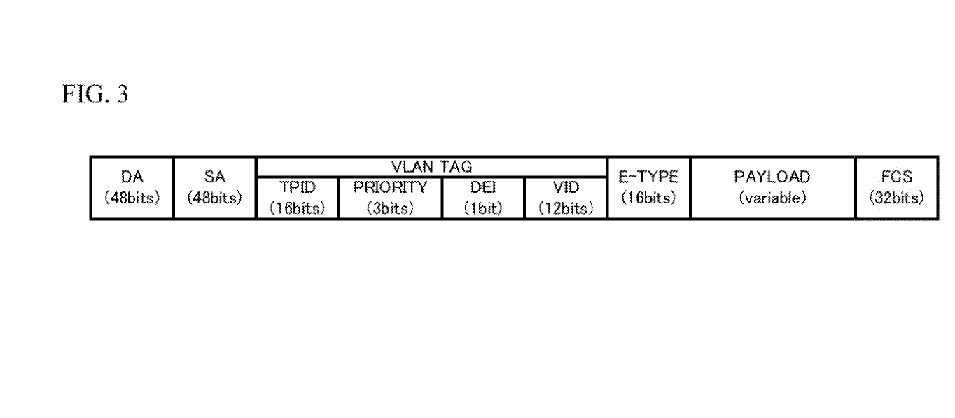

FIG. 3 is a configuration diagram illustrating an example of a format of the packet. In the present embodiment, the Ethernet frame is considered as the packet, but the packet is not limited to this. Moreover, in the present embodiment, an Ethernet frame with a VLAN tag is considered as the packet, but an Ethernet frame without the VLAN tag may be used. In FIG. 3, in brackets of each region, the length of the region (a data amount) is illustrated.

The Ethernet frame includes a DA (Destination Address) that is a MAC (Media Access Control) address of the destination, a SA (Source Address) that is a MAC address of a transmission source, the VLAN (Virtual Local Area Network) tag, an E-type, a payload, and a FSC (Frame Check Sequence).

The E-type is an Ethernet type, and indicates a message type of a high-order layer stored into the variable length payload. When the E-type is “0x8100” (“0x” is a hexadecimal form) for example, it indicates IPv4 (Internet Protocol version 4). Here, a value of the Ethernet type is defined by IANA (Internet Assigned Number Authority).

The FCS is a correction code for a data error. For example, a CRC (Cyclic Redundancy Check)-32 is used as the FCS, but the FCS is not limited to this.

The VLAN tag includes a TPID (Tag Protocol Identifier), a PRIORITY, a DEI (Discard Eligibility Indicator), and a VID (VLAN Identifier). The TPID is one type of the Ethernet type, and indicates that the VID is stored in a subsequent stage. A value of TPID is defined as “0x8100” by IEEE (the Institute of Electrical and Electronics Engineers, Inc.) 802.1Q.

The PRIORITY indicates a priority of the Ethernet frame. The DEI is a priority of discard of the Ethernet frame. The Ethernet frame of “DEI=1” is discarded more preferentially than the Ethernet frame of “DEI=0”. The VID is an identifier that identifies a line. Here, the Ethernet frame can be stored in a state where a plurality of VLAN tags are stacked.

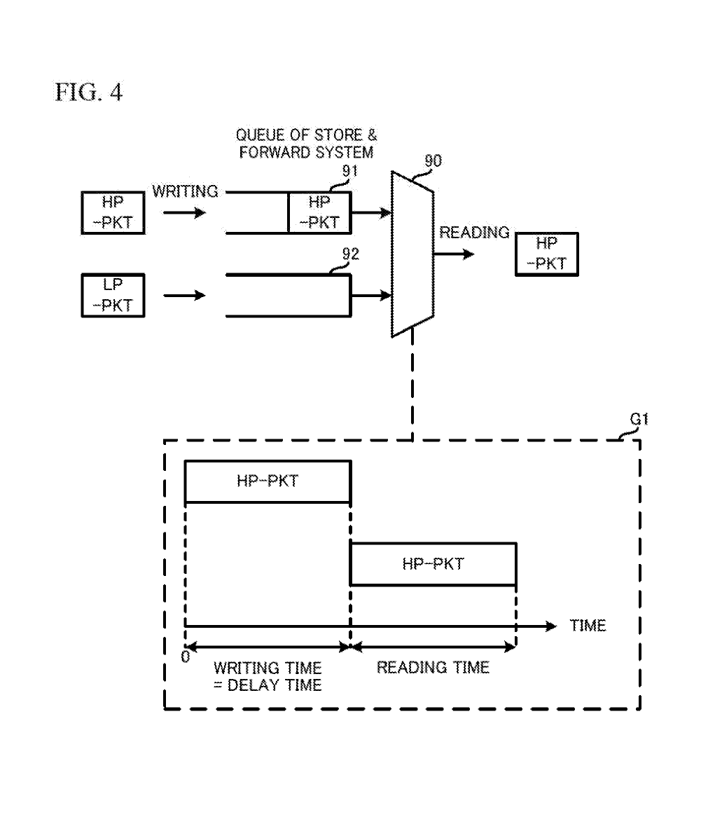

FIG. 4 is a diagram illustrating an example of a delay time of the packet in the queue configuration of a comparative example. The packet transfer device 1 of the comparative example includes queues 91 and 92 provided for each priority of the packet, and a reading control circuit 90.

Each of the queues 91 and 92 is a buffer for packet storage configured by a memory, for example. A high priority packet (HP-PKT) is written into the queue 91, and a low priority packet (LP-PKT) is written into the queue 92. Here, the high priority packet and the low priority packet are identified based on the priority in the VLAN tag, for example.

The reading control circuit 90 reads the high priority packet from the queue 91, and reads the low priority packet from the queue 92. The reading control circuit 90 reads the high priority packet more preferentially than the low priority packet. The high priority packet and the low priority packet are read from the queues 91 and 92 according to a store and forward system. More specifically, after a rear end of the high priority packet is input to the queue 91, the reading control circuit 90 begins to read the high priority packet from the head thereof. After a rear end of the low priority packet is input to the queue 92, the reading control circuit 90 begins to read the low priority packet from the head thereof. That is, after storing the high priority packet and the low priority packet in the queues 91 and 92 is completed, the reading control circuit 90 reads the high priority packet and the low priority packet stored into the queues 91 and 92.

When the low priority packet is not stored in the queue 92, a code G1 illustrates a time chart relating to the delay time when the high priority packet is read from the queue 91 after the high priority packet is written into the queue 91. To read the high priority packet according to the store and forward system, the reading control circuit 90 begins to read the high priority packet after the storage of the high priority packets is completed.

For this reason, after a writing time required to write the high priority packet into the queue 91 has elapsed, the reading time required to read the high priority packet from the queue 91 begins. Therefore, a delay time corresponding to the writing time occurs in the transfer of the high priority packet.

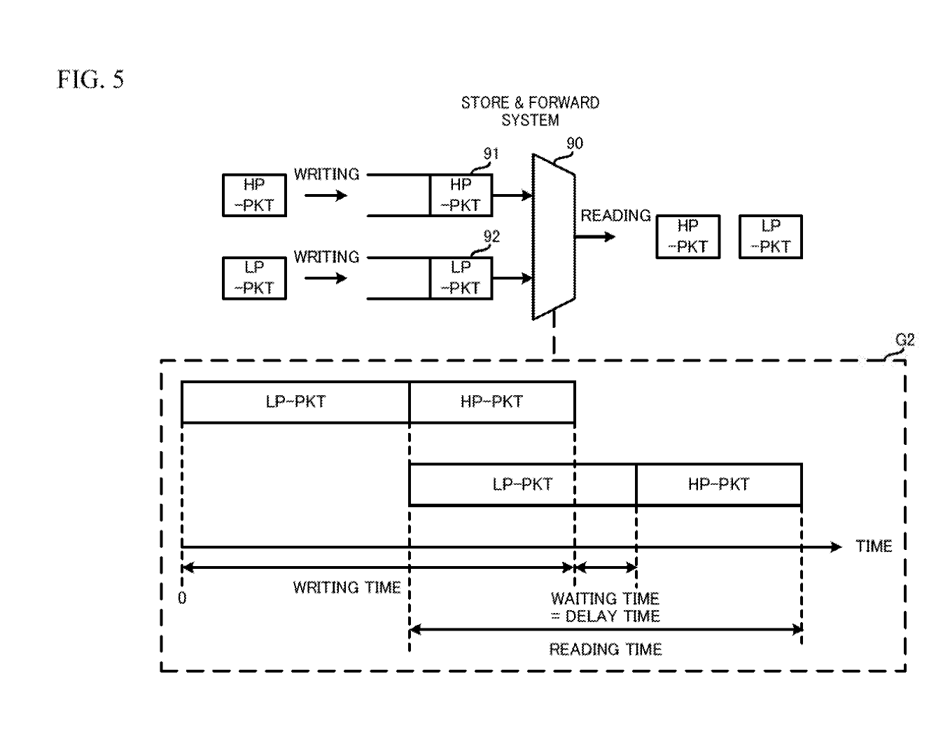

FIG. 5 is a diagram illustrating another example of the delay time of the packet in the queue configuration of the comparative example. In FIG. 5, elements corresponding to those of FIG. 4 are designated by identical reference numerals, and description thereof is omitted.

A code G2 illustrates a time chart relating to the delay time when the low priority packet is read prior to the high priority packet in a state where the high priority packet is written into the queue 91 after the low priority packet is written into the queue 92. Thus, as a case where the low priority packet is read prior to the high priority packet, a case where the reading of the high priority packet is continuous immediately before that is considered, for example.

The reading of the low priority packet is begun immediately after the low priority packet are written into the queue 92, but the reading of the high priority packet is not begun until the reading of the low priority packet is completed. For this reason, a waiting time in which the high priority packet waits in the queue 91 occurs until the reading of the low priority packet is completed. Therefore, in the transfer of the high priority packet, a delay time corresponding to the waiting time occurs in addition to the delay time corresponding to the writing time.

The larger a difference between packet lengths of the high priority packet and the low priority packet, the longer the delay time corresponding to the waiting time. For this reason, when the high priority packet is a packet having a short packet length such as the voice packet, the delay time increases and the communication service is easily influenced by the increase of the delay time. Therefore, in the case of the queue configuration of the comparative example, there is a problem that the delay is not reduced in even the high priority packet.

Consequently, in the present embodiment, a queue in which the packet is read in accordance with a cut-through system is provided in addition to the queues in which the packet is read in accordance with the store and forward system. Thereby, the reading of the packet with low delay is realized by the cut-through system.

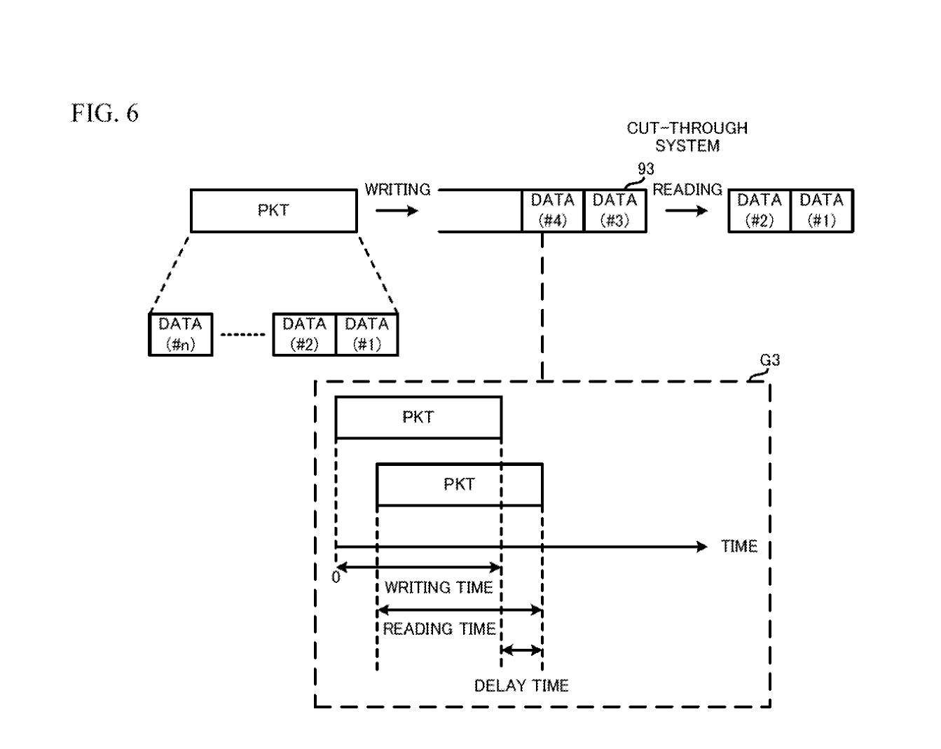

FIG. 6 is a diagram illustrating an example of writing operation and reading operation of the packet in accordance with the cut-through system using a single queue. The packet (PKT) is divided into a plurality of pieces of data (#1, #2, . . . , #n) (n: positive integer), and the plurality of pieces of data are stored into a queue 93.

According to the cut-through system, the reading of the packet is begun before all of the data (#1, #2, . . . , #n) are written into the queue 93. FIG. 6 illustrates that the data (#1) and the data (#2) are read in a state where the data (#3) and the data (#4) are stored into the queue 93 and the following data (#5, . . . , #N) are not stored therein.

That is, the head data (#1) is read from the queue 93 before the last data (#N) is written into the queue 93 at the latest. Reading start timing of the packet can be set as timing in which the DA in the Ethernet frame is detected from the data stored into the queue 93 for example, but is not limited to this.

A code G3 illustrates a time chart relating to the delay time of the packet. In the cut-through system, the reading of the packet from the queue 93 is begun before storing the packet into the queue 93 is completed. For this reason, the writing time required for the writing of the packet and the reading time required for the reading of the packet partially overlap with each other. Therefore, a remainder of the reading time after the completion of the writing time becomes the delay time.

On the contrary, in the store and forward system, the reading of the packet is begun after the storage of the packet is completed, as described above. Therefore, the delay time (i.e., the waiting time) due to the reading of another packet from another queue (see FIG. 5) occurs in addition to the delay time (i.e., the writing time) due to the writing of the packet (see FIG. 4). Therefore, in the cut-through system, the delay time is reduced compared with the store and forward system.

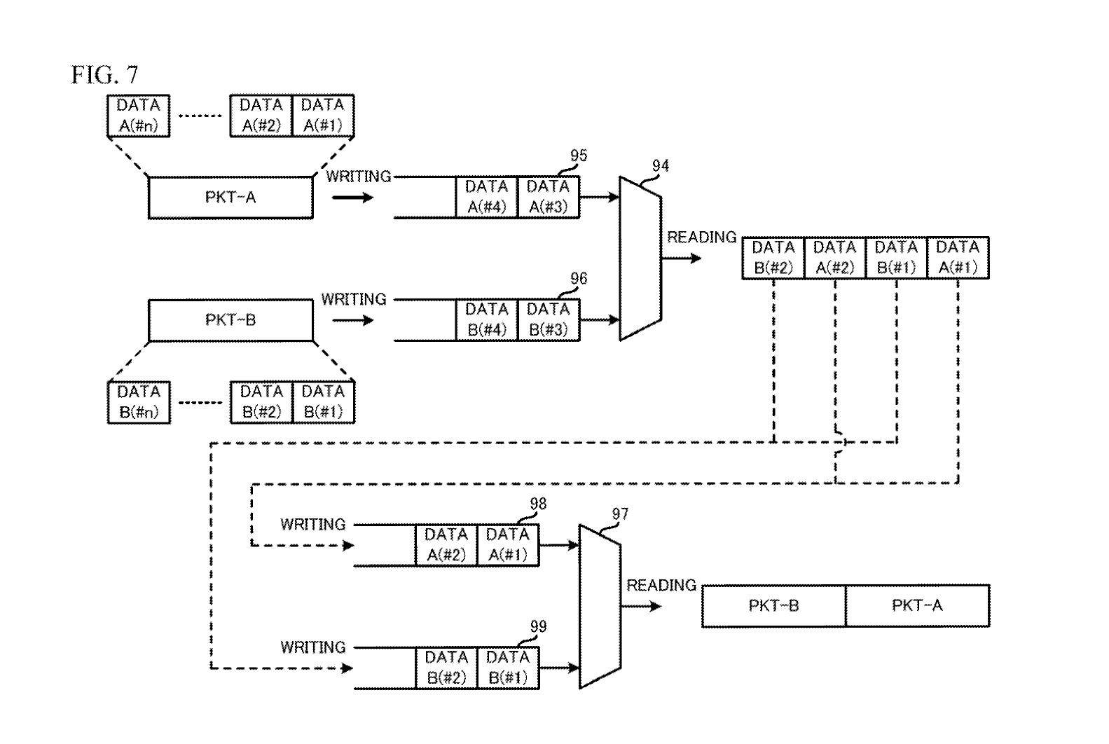

FIG. 7 is a diagram illustrating an example of the writing operation and the reading operation of the packet in accordance with the cut-through system using a plurality of queues. In this example, a packet A (PKT-A) is divided into a plurality of pieces of data A (#1, #2, . . . , #n), and the plurality of pieces of data A are stored into a queue 95. A packet B (PKT-B) is divided into a plurality of pieces of data B (#1, #2, . . . , #n), and the plurality of pieces of data B are stored into a queue 96.

A reading control circuit 94 reads the data A and the data B from the two queues 95 and 96 in accordance with the cut-through system, respectively. That is, the reading control circuit 94 begins to read the packet A from the queue 95 before storing the packet A into the queue 95 is completed, and begins to read the packet B from the queue 95 before storing the packet B into the queue 96 is completed.

A reading control circuit 94 evenly reads the data A and the data B from the queues 95 and 96 in accordance with a round-robin system, respectively. For this reason, the data A and the data B are read alternately from the readout control circuit 94 in an order of the data A (#1), the data B (#1), the data A (#2) and the data B (#2), for example.

The data A and the data B read from the reading control circuit 94 are written into separate queues 98 and 99 in order to reconfigure the packet A and the packet B, respectively. The plurality of pieces of data A constituting the packet A are stored into the queue 98, and the plurality of pieces of data B constituting the packet B are stored into the queue 99.

A reading control circuit 97 reconfigures the packet A from the plurality of pieces of data A (#1, #2, . . . , #n) stored into the queue 98, and reconfigures the packet B from the plurality of pieces of data B (#1, #2, . . . , #n) stored into the queue 99. Segment header information used for the reconfiguration of each of the packet A and the packet B in segmentation processing is imparted to each of the data A and the data B.

For example, a packet number and a sequence number are included in the segment header information. For example, a packet number “A” and a sequence number “#1” are imparted to the data A (#1), and the packet number “A” and a sequence number “#n” are imparted to the data A (#n). Also, a packet number “B” and the sequence number “#1” are imparted to the data B (#1), and the packet number “B” and the sequence number “#n” are imparted to the data B (#n).

The reading control circuit 97 reconfigures the packet A and the packet B based on the plurality of pieces of segment header information of the data A and the data B read from the queues 98 and 99. Thus, when the queues 95 and 96 are used in the cut-through system, the queues 98 and 99 and the reading control circuit 97 for reconfiguring the packets are provided. In the following embodiment, the cut-through system using a single queue is explained, but the plurality of queues can be also used as illustrated in FIG. 7.

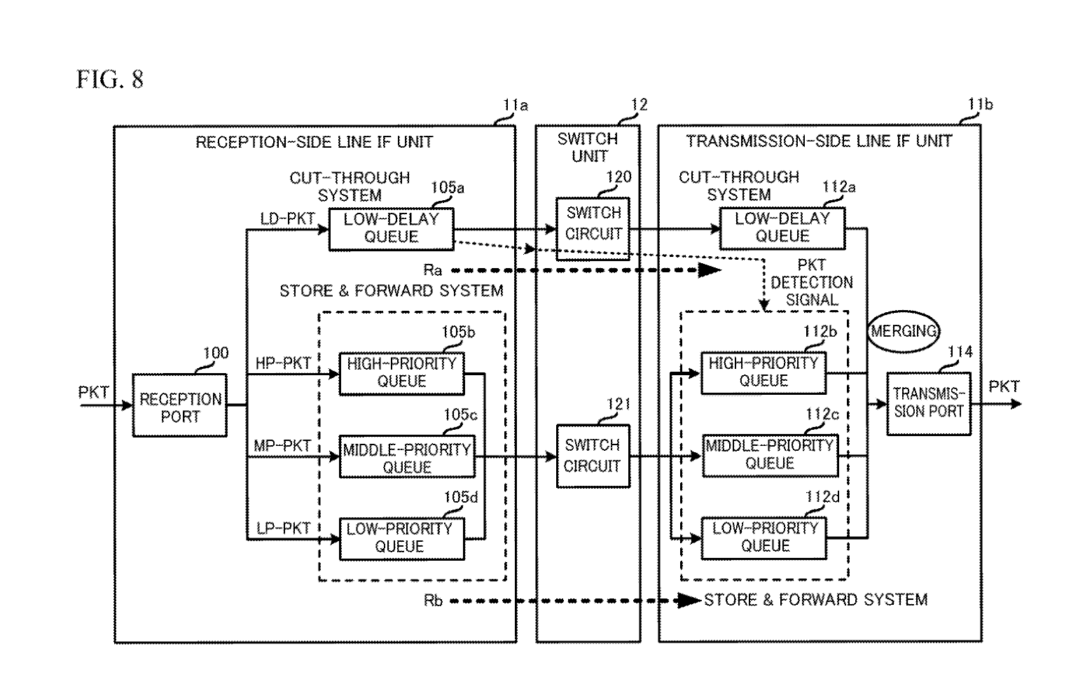

FIG. 8 is a configuration diagram illustrating the queue configuration of the packet transfer device 1 according to an embodiment. In FIG. 8, a reception-side line IF unit 11a is the line IF unit 11 receiving the packet (PKT), and a transmission-side line IF unit 11b is the line IF unit 11 transmitting the packet. A reception port 100 is a communication port P receiving the packet, and a transmission port 114 is a communication port P transmitting the packet.

In the reception-side line IF unit 11a, the packet received by the reception port 100 is identified as the high priority packet (HP-PKT), the middle priority packet (MP-PKT) or the low priority packet (LP-PKT), based on the PRIORITY (see FIG. 3) for example. The packet which satisfies a given condition among the high priority packet, the middle priority packet and the low priority packet is identified as a low delay packet (LD-PKT) that is transferred with lower delay than other packets. Here, the low delay packet is an example of a first priority packet. The high priority packet, the middle priority packet and the low priority packet other than the low delay packet are an example of a second priority packet having a lower priority than the first priority packet.

The reception-side line IF unit 11a includes: a low delay queue 105a from which the packet is read in accordance with the cut-through system; and a high priority queue 105b, a middle priority queue 105c and a low priority queue 105d from which the packet is read in accordance with the store and forward system. The low delay packet is stored into the low delay queue 105a, and the high priority packet is stored into the high priority queue 105b. Moreover, the middle priority packet is stored into the middle priority queue 105c, and the low priority packet is stored into the low priority queue 105d. Here, the low delay queue 105a is an example of a first storage, and the high priority queue 105b, the middle priority queue 105c and the low priority queue 105d is an example of a second storage. Moreover, the high priority queue 105b, the middle priority queue 105c and the low priority queue 105d may be provided in separate memories, or may be provided in separate storage areas in a common memory.

The switch unit 12 includes: a switch circuit 120 that outputs the low delay packet to the transmission-side line IF unit 11b corresponding to the destination of the low delay packet; and a switch circuit 121 that outputs each of the high priority packet, the middle priority packet and the low priority packet to the transmission-side line IF unit 11b corresponding to the destination of each packet. The switch circuits 120 and 121 are configured by the FPGA, for example, and have a common packet exchanging function. Here, the switch circuits 120 and 121 are not provided separately for each line IF unit 11, but are provided in common to the plurality of line IF units 11.

The low delay packet read from the low delay queue 105a is input to the switch circuit 120. The high priority packet, the middle priority packet and the low priority packet read from the high priority queue 105b, the middle priority queue 105c and the low priority queue 105d, respectively are input to the switch circuit 121. The switch circuit 120 outputs the low delay packet to the transmission-side line IF unit 11b corresponding to the destination of the low delay packet. The switch circuit 121 outputs each of the high priority packet, the middle priority packet and the low priority packet to the transmission-side line IF unit 11b corresponding to the destination of each packet.

The transmission-side line IF unit 11b includes: a low delay queue 112a from which the packet is read in accordance with the cut-through system; and a high priority queue 112b, a middle priority queue 112c and a low priority queue 112d from which the packet is read in accordance with the store and forward system. The low delay packet input from the switch circuit 120 is stored into the low delay queue 112a, and the high priority packet input from the switch circuit 121 is stored into the high priority queue 112b.

Moreover, the middle priority packet input from the switch circuit 121 is stored into the middle priority queue 112c, and the low priority packet input from the switch circuit 121 is stored into the low priority queue 112d. Here, the low delay queue 112a is an example of a third storage, and the high priority queue 112b, the middle priority queue 112c and the low priority queue 112d is an example of a fourth storage.

Thus, the low delay packet is read from the low delay queue 112a in accordance with the cut-through system. The high priority packet, the middle priority packet and the low priority packet are read from the high priority queue 112b, the middle priority queue 112c and the low priority queue 112d in accordance with the store and forward system, respectively.

Therefore, the low delay packet is output from the reception-side line IF unit 11a with a less delay time than the high priority packet, the middle priority packet and the low priority packet. For this reason, the reception-side line IF unit 11a transfers, for example, the voice packet for which the low delay is required as the low delay packet which is not simply the high priority packet, so that it is possible to suppress the decrease in a communication quality.

The low delay packet is read from the low delay queue 112a and is input to the transmission port 114. The high priority packet is read from the high priority queue 112b and is input to the transmission port 114. The middle priority packet is read from the middle priority queue 112c and is input to the transmission port 114. The low priority packet is read from the low priority queue 112d and is input to the transmission port 114. The transmission port 114 transmits the low delay packet, the high priority packet, the middle priority packet and the low priority packet to other device via a transmission path. Here, the transmission port 114 is an example of a transmitter.

The low delay packet differs from the high priority packet, the middle priority packet and the low priority packet in routes Ra and Rb from the reception port 100 to the transmission port 114. More specifically, the low delay packet is input to the transmission port 114 through the route Ra including the switch circuit 120. On the other hand, the high priority packet, the middle priority packet and the low priority packet are input to the transmission port 114 through the route Rb including the switch circuit 121.

The route Ra for the low delay packet and the route Rb for the high priority packet, the middle priority packet and the low priority packet are provided independently of each other without an overlapping part. Therefore, the low delay packet does not merge with the high priority packet, the medium-priority packet and the low priority packet on the route Ra, and is output from the reception-side line IF unit 11a to the transmission-side line IF unit 11b with lower delay than these packets.

The low delay packet merges with the high priority packet, the middle priority packet and the low priority packet in the transmission port 114. For this reason, while the packet is being read from any one of the high priority queue 112b, the middle priority queue 112c and the low priority queue 112d, the low delay packet is not readable from the low delay queue 112a, resulting in the delay time as illustrated in FIG. 5.

Therefore, when the low delay packet is stored into the low delay queue 105a, the reception-side line IF unit 11a outputs a packet detection signal (PKT detection signal) for notifying the detection of the low delay packet to the transmission-side line IF unit 11b via the switch circuit 120. When the packet detection signal is input, the transmission-side line IF unit 11b restricts the reading of the packet from the high priority queue 112b, the middle priority queue 112c and the low priority queue 112d.

Thereby, the low delay packet is read from the low delay queue 112a more preferentially than the high priority packet, the middle priority packet and the low priority packet, and therefore the delay time in the transmission-side line IF unit 11b is reduced. Hereinafter, the configuration of the reception-side line IF unit 11a and the transmission-side line IF unit 11b is described.

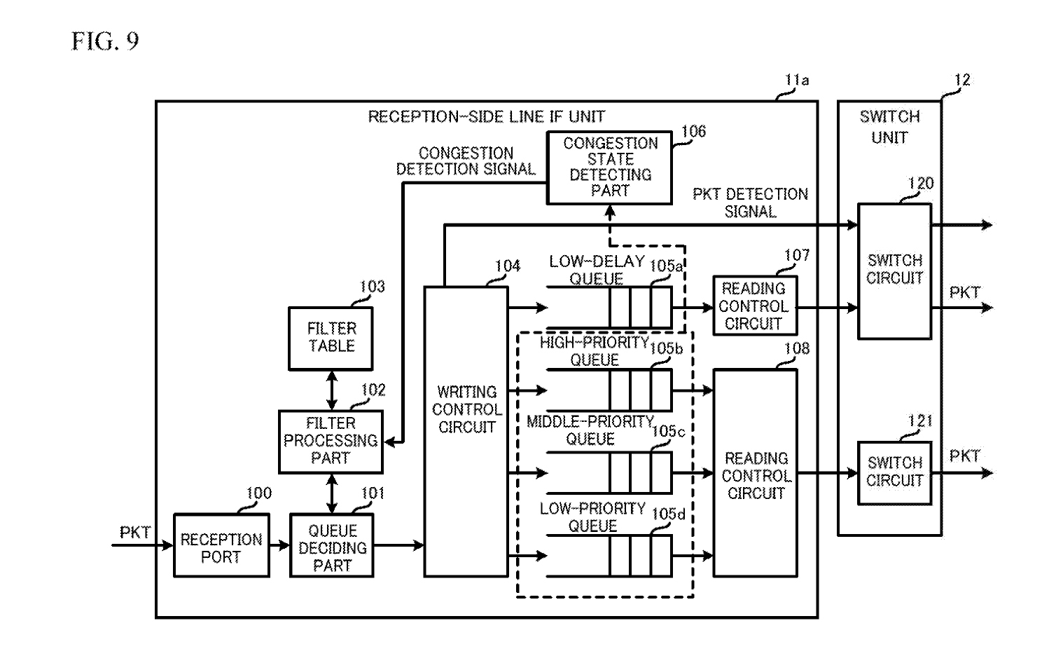

FIG. 9 is a configuration diagram illustrating an example of the reception-side line IF unit 11a. In FIG. 9, elements corresponding to those of FIG. 8 are designated by identical reference numerals, and description thereof is omitted.

The reception-side line IF unit 11a includes the reception port 100, a queue deciding part 101, a filter processing part 102, a filter table 103, a writing control circuit 104, the low delay queue 105a, the high priority queue 105b, the middle priority queue 105c and the low priority queue 105d. Moreover, the reception-side line IF unit 11a includes a congestion state detecting part 106 and reading control circuits 107 and 108.

The packet (PKT) received by the reception port 100 is input to the queue deciding part 101. The queue deciding part 101 decides a storage queue for storing the packet from the low delay queue 105a, the high priority queue 105b, the middle priority queue 105c and the low priority queue 105d. The queue deciding part 101 decides the storage queue for each packet in cooperation with the filter processing part 102, and imparts an identifier of the storage queue to the packet. The packet to which the identifier of the storage queue is imparted is input to the writing control circuit 104. Here, the filter processing part 102 is configured as a filter processing circuit by the FPGA or a network processor as an example, and the queue deciding part 101 is configured as a queue deciding circuit by the FPGA or the network processor as an example.

The writing control circuit 104 writes the packet into the queue corresponding to the identifier of the storage queue among the low delay queue 105a, the high priority queue 105b, the middle priority queue 105c and the low priority queue 105d. More specifically, the writing control circuit 104 inputs the low delay packet to the low delay queue 105a, and inputs the high priority packet to the high priority queue 105b. The writing control circuit 104 inputs the middle priority packet to the middle priority queue 105c, and inputs the low priority packet to the low priority queue 105d. Here, the writing control circuit 104 is an example of an inputter.

The reading control circuit 107 reads the low delay packet from the low delay queue 105a and outputs the low delay packet to the switch circuit 120. The reading control circuit 107 reads the low delay packet in accordance with the cut-through system. More specifically, the reading control circuit 107 begins to read the head of the low delay packet before the end of the low delay packet is input to the low delay queue 105a. That is, the reading control circuit 107 reads the low delay packet stored into the low delay queue 105a before storing the low delay packet into the low delay queue 105a is completed. Here, the reading control circuit 107 is an example of a first reader.

On the other hand, the reading control circuit 108 reads the high priority packet, the middle priority packet and the low priority packet from the high priority queue 105b, the middle priority queue 105c and the low priority queue 105d, respectively, and outputs the packets to the switch circuit 121. The reading control circuit 108 reads the high priority packet, the middle priority packet and the low priority packet in accordance with the store and forward system. More specifically, the reading control circuit 108 begins to read the head of the high priority packet after the end of the high priority packet is input to the high priority queue 105b. The reading control circuit 108 begins to read the head of the middle priority packet after the end of the middle priority packet is input to the middle priority queue 105c. The reading control circuit 108 begins to read the head of the low priority packet after the end of the low priority packet is input to the low priority queue 105d. That is, after storing the packets into the queues 105b to 105d is completed, the reading control circuit 108 reads the packets stored into the queues 105b to 105d. Here, the reading control circuit 108 is an example of a second reader.

Thus, the low delay packet is read from the low delay queue 105a in accordance with the cut-through system. The high priority packet, the middle priority packet and the low priority packet are read from the high priority queue 105b, the middle priority queue 105c and the low priority queue 105d in accordance with the store and forward system, respectively.

Therefore, the low delay packet is output from the reception-side line IF unit 11a with a less delay time than the high priority packet, the middle priority packet and the low priority packet. Here, each of the writing control circuit 104 and the reading control circuits 107 and 108 is configured as a function of a logic circuit or the network processor such as the FPGA.

When the writing control circuit 104 inputs the low delay packet to the low delay queue 105a, the writing control circuit 104 restricts the reading of the packet from the high priority queue 112b, the middle priority queue 112c and the low priority queue 112d by outputting the packet detection signal to the transmission-side line IF unit 11b.

The congestion state detecting part 106 detects the congestion of the packets in the high priority queue 112b, the middle priority queue 112c and the low priority queue 112d. The congestion state detecting part 106 monitors an input rate of the packet to each of the queue 105b to 105d and a data amount of the packet stored into each of the queue 105b to 105d, and detects a congestion state based on the monitoring result. Here, the congestion state detecting part 106 is an example of a detector, and is configured as a congestion state detecting circuit by the FPGA or the network processor, for example.

A detection condition of the congestion state is set to the congestion state detecting part 106 from the control unit 10, for example. Thereby, when the input rate of the packet to each of the queue 105b to 105d or the data amount of the packet stored into each of the queue 105b to 105d exceeds a given value, the congestion state detecting part 106 can detect the congestion state. When the congestion state detecting part 106 has detected the congestion state, the congestion state detecting part 106 outputs a congestion detection signal for each of the high priority queue 105b, the middle priority queue 105c and the low priority queue 105d to the filter processing part 102.

The filter processing part 102 performs filtering processing on the packet input to the queue deciding part 101 based on the filter table 103. The presence or absence of input of the congestion detection signal is reflected to the filtering processing. The filter processing part 102 notifies the queue deciding part 101 of a result of the filtering processing.

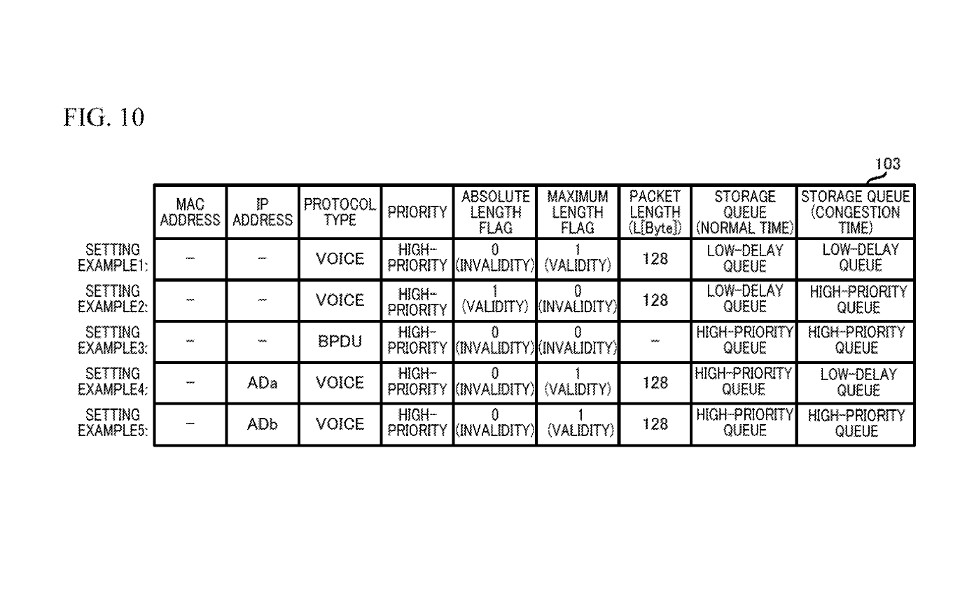

FIG. 10 is a diagram illustrating an example of the filter table 103. The filter table 103 is stored into a storage device such as a nonvolatile memory, and the content of the filter table 103 is set by the control unit 10.

A “MAC address”, an “IP address”, a “protocol type”, a “priority”, an “absolute length flag”, a “maximum length flag”, a “packet length (L[Byte])”, a “storage queue (normal time)” and a “storage queue (congestion time)” are registered into the filter table 103.

The “MAC address” is an MAC address (DA) of the destination of the packet, and the “IP address” is an IP address of the destination of the packet, for example. More specifically, the “IP address” is a destination IP address of an IP packet accommodated in the payload of the Ethernet frame. Here, a code “-” of FIG. 10 indicates that a corresponding condition is not registered, i.e., is invalidity.

The “protocol type” is a protocol type of the packet. The “protocol type” is identified by a protocol number of the IP packet accommodated in the payload of the Ethernet frame. In this example, a voice protocol and a protocol of a BPDU (Bridge Protocol Data Unit) are considered as the “protocol type”, but the “protocol type” is not limited to these.

The “priority” is a priority of the packet. The “priority” is identified based on the priority in the VLAN tag.

The “absolute length flag” and the “maximum length flag” are flags that set the validity or invalidity of the condition of the “packet length”. Any one of the “absolute length flag” and the “maximum length flag” is set to “1 (validity)”. Alternatively, both of the “absolute length flag” and the “maximum length flag” are set to “0 (invalidity)”.

When the “absolute length flag” is “1”, the “packet length” indicates a condition that the packet length (data amount) is a setting value L (Byte). When the “maximum length flag” is “1”, the “packet length” indicates a condition that the packet length (data amount) is equal to or less than the setting value L (Byte). For example, in the case of a setting example 2, the “absolute length flag” is “1” and the “packet length” is 128 (Byte). Therefore, only the packet in which the “packet length” is 128 (Byte) among the high priority packets in which the “protocol type” is the voice protocol satisfies the condition.

In the case of a setting example 1, the “maximum length flag” is “1” and the “packet length” is 128 (Byte). Therefore, only the packet in which the “packet length” is equal to or less than 128 (Byte) among the high priority packets in which the “protocol type” is the voice protocol satisfies the condition.

The “storage queue (normal time)” indicates any one of the queues 105a to 105d storing the packet when the congestion does not occur. The “storage queue (congestion time)” indicates any one of the queues 105a to 105d storing the packet when the congestion occurs in the queue indicated by the “storage queue (normal time)”.

In the case of the setting example 2, only the packet in which the “packet length” is 128 (Byte) among the high priority voice packets is stored into the low delay queue 105a. In the case of the setting example 1, only the packet in which the “packet length” is equal to or less than 128 (Byte) among the high priority voice packets is stored into the low delay queue 105a. Therefore, the voice packet for which the low delay is required can be identified based on whether to satisfy the condition of the packet length, and be output with low delay. In the case of the setting example 1, both of the “storage queue (normal time)” and the “storage queue (congestion time)” are set to the low delay queue 105a, and hence the packet which satisfies the condition is stored into the low delay queue 105a also in the case of the congestion of the low delay queue 105a.

In the case of the setting example 3, since both of the “absolute length flag” and the “maximum length flag” are “0”, there is no condition of the “packet length”, and all the high priority BPDU packets are stored into the high priority queue 105b. The BPDU packets are high priority packets, but a request of the low delay is not as stringent as the voice packet, and hence storing the BPDU packets into the high priority queue 105b does not substantially affect the quality of the communication.

In the setting examples 4 and 5, the storage queues are different from each other depending on the IP address of the destination when the congestion occurs in the high priority queue 105b. According to the setting examples 4 and 5, only the packet in which the “packet length” is equal to or less than 128 (Byte) among the high priority voice packets in which the destination IP address is “Ada” or “ADb” is stored into the high priority queue 105b.

In the case of the setting example 5, the “storage queue (congestion time)” is set to the high priority queue 105b as with the “storage queue (normal time)”. On the other hand, in the case of the setting example 4, the “storage queue (congestion time)” is set to the low delay queue 105a unlike the “storage queue (normal time)”. Therefore, when the congestion occurs in the high priority queue 105b, the storage queue of the packet in which the destination IP address is “ADa” is switched from the high priority queue 105b to the low delay queue 105a. However, the storage queue of the packet in which the destination IP address is “ADb” is maintained to the high priority queue 105b.

Therefore, when the congestion occurs in the high priority queue 105b, the delay time of the packet in which the destination IP address is “ADa” is reduced, but the delay time of the packet in which the destination IP address is “ADb” is not reduced. Thus, according to the setting examples 4 and 5, it is possible to differentiate the communication quality depending on the destination IP address. For example, when the packet in which the destination IP address is “ADa” is set as the packet of a normal mobile network operator, and the packet in which the destination IP address is “ADb” is set as the packet of a mobile virtual network operator (MVNO), it is possible to differentiate the service quality of both network operators.

Referring to FIG. 9 again, the filter processing part 102 performs the filtering processing on the packet based on the condition set in the filter table 103. The filter processing part 102 determines whether the storage queue is any of the low delay queue 105a or the high priority queue 105b by the filtering processing on the basis of the packet length, as illustrated in the above setting examples 1 and 2.

That is, the filter processing part 102 identifies the low delay packet and the high priority packet from the packets input from the queue deciding part 101 based on the packet length. The low delay packet and the high priority packet are input to the low delay queue 105a and the high priority queue 105b, respectively, by the writing control circuit 104 according to a result of the identification. Therefore, the filter processing part 102 can control the delay time of the packet according to the packet length.

More specifically, when the packet length is equal to or less than the given setting value L, the filter processing part 102 sets the storage queue to the low delay queue 105a, as in the setting example 1. When the packet length is longer than the given setting value L, the filter processing part 102 sets the storage queue to the high priority queue 105b. That is, when the packet length is equal to or less than the given setting value L, the filter processing part 102 identifies the packet as the low delay packet. When the packet length is longer than the given setting value L, the filter processing part 102 identifies the packet as the high priority packet. Therefore, the filter processing part 102 can reduce the delay time of the packet in which the packet length is equal to or less than the given setting value L.

Moreover, when the packet length is the given setting value L, the filter processing part 102 sets the storage queue to the low delay queue 105a, as in the setting example 2. When the packet length is not the given setting value L, the filter processing part 102 sets the storage queue to the high priority queue 105b. That is, when the packet length is the given setting value L, the filter processing part 102 identifies the packet as the low delay packet. When the packet length is not the given setting value L, the filter processing part 102 identifies the packet as the high priority packet. Therefore, the filter processing part 102 can reduce the delay time of the packet in which the packet length is the given setting value L.

Moreover, the filter processing part 102 switches the storage queue according to a detection result of the congestion of the packet in the high priority queue 105b, as in the setting example 4. Normally, the filter processing part 102 sets the storage queue to the high priority queue 105b. When the congestion of the packet occurs in the high priority queue 105b, the filter processing part 102 sets the storage queue to the low delay queue 105a. That is, the filter processing part 102 identifies the low delay packet and the high priority packet from the packets input from the queue deciding part 101 in accordance with the detection result of the congestion state detecting part 106.

Therefore, when the congestion of the packet occurs in the high priority queue 105b, the filter processing part 102 switches the storage queue to the low delay queue 105a, and can therefore reduce the delay time of the packet. Here, each of the filter processing part 102, the queue deciding part 101 and the congestion state detecting part 106 is configured as a function of the FPGA or the network processor, for example.

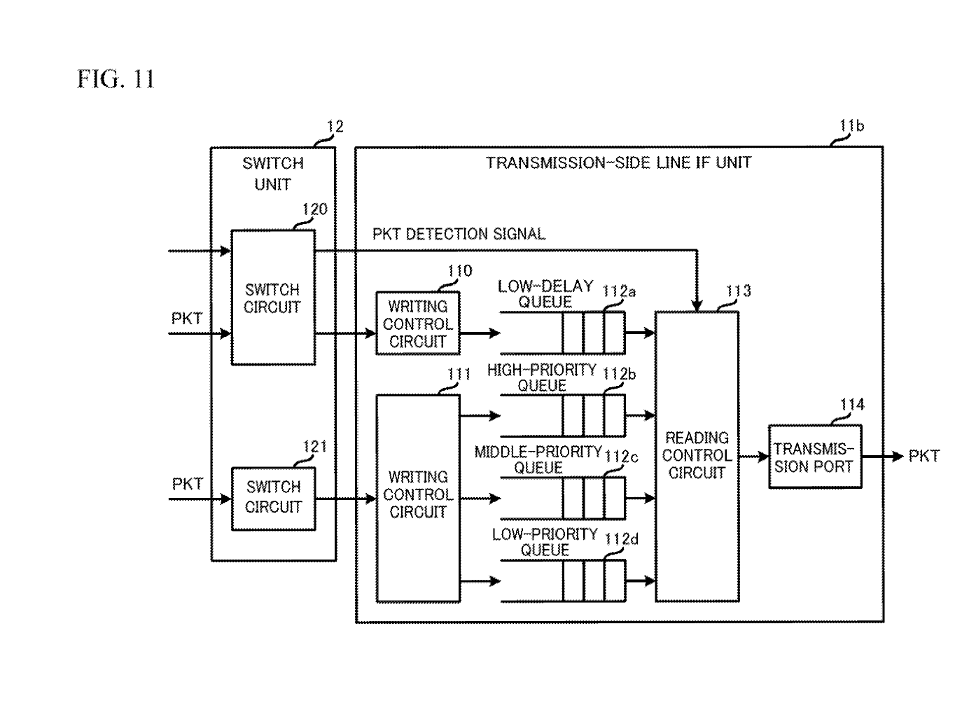

FIG. 11 is a configuration diagram illustrating an example of the transmission-side line IF unit 11b. In FIG. 11, elements corresponding to those of FIG. 8 are designated by identical reference numerals, and description thereof is omitted. The transmission-side line IF unit 11b includes writing control circuits 110 and 111, the low delay queue 112a, the high priority queue 112b, the middle priority queue 112c, the low priority queue 112d, a reading control circuit 113 and the transmission port 114.

The writing control circuit 110 writes the low delay packet input from the switch circuit 120 into the low delay queue 112a. The writing control circuit 111 writes the high priority packet, the middle priority packet and the low priority packet input from the switch circuit 121 into the high priority queue 112b, the middle priority queue 112c and the low priority queue 112d, respectively. Here, the writing control circuit 111 distributes the packets to the high priority queue 112b, the middle priority queue 112c and the low priority queue 112d, based on the identifier of the storage queue imparted to the packets.

The reading control circuit 113 reads the low delay packet from the low delay queue 112a, and outputs the low delay packet to the transmission port 114. Moreover, the reading control circuit 113 reads the high priority packet, the middle priority packet and the low priority packet from the high priority queue 112b, the middle priority queue 112c and the low priority queue 112d, respectively, and outputs these packet to the transmission port 114.

In this case, when the low delay packet merges with the high priority packet, the middle priority packet and the low priority packet as described above, the delay time occurs. Therefore, the reading control circuit 113 stops reading the packet from the high priority queue 112b, the middle priority queue 112c and the low priority queue 112d in accordance with the packet detection signal input from the reception-side line IF unit 11a via the switch circuit 120. Here, a stop period may be a period until the reading of the low delay packet from the low delay queue 112a is completed, or may be a predetermined period, for example.

Thus, when the low delay packet is input to the low delay queue 105a, the writing control circuit 104 of the reception-side line IF unit 11a restricts the reading of the packet from the high priority queue 112b, the middle priority queue 112c and the low priority queue 112d in the transmission-side line IF unit 11b. Therefore, in the transmission-side line IF unit 11b, it is suppressed that the delay time occurs in the low delay packet. Here, each of the writing control circuit 110 and the reading control circuit 113 is configured as a function of the FPGA or the network processor, for example.

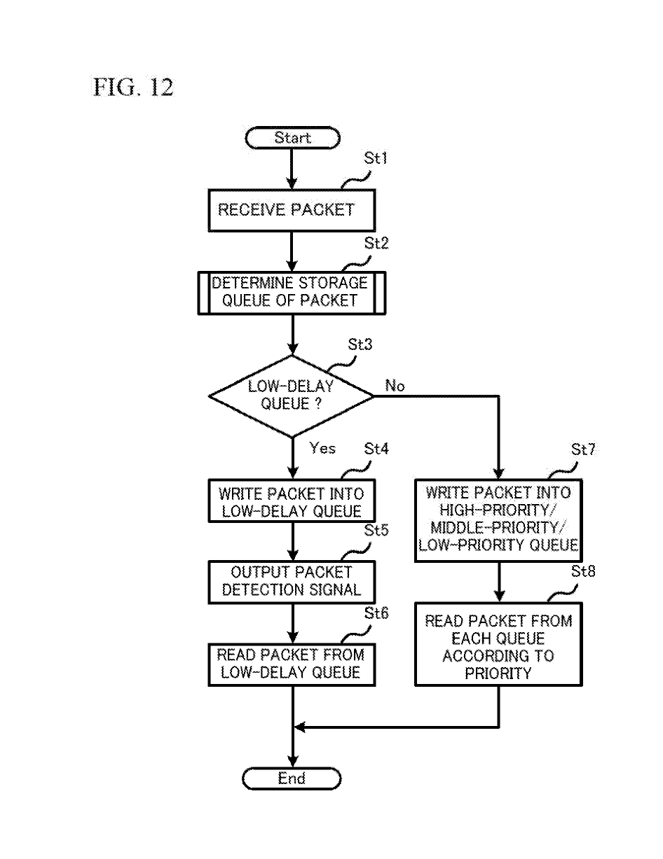

FIG. 12 is a flowchart illustrating an example of the operation of the reception-side line IF unit 11a. First, the reception port 100 receives the packet (step SU). Next, the queue deciding part 101 determines the storage queue of the packet (step St2). The queue deciding part 101 imparts the identifier of the storage queue to the packet based on the result of the determination. Here, the determination processing is described later.

Next, the writing control circuit 104 determines whether the storage queue is the low delay queue 105a, based on the identifier of the storage queue (step St3). When the storage queue is the low delay queue 105a (Yes in step St3), the writing control circuit 104 writes the low delay packet into the low delay queue 105a (step St4). Next, the writing control circuit 104 outputs the packet detection signal to the transmission-side line IF unit 11b (step St5).

Next, the reading control circuits 107 reads the low delay packet from the low delay queue 105a in accordance with the cut-through system, and outputs the low delay packet to the switch circuit 120 (step St6). Thereby, the low delay packet is input to the transmission port 114 via the route Ra.

Moreover, when the storage queue is the high priority queue 105b, the middle priority queue 105c or the low priority queue 105d (No in step St3), the writing control circuit 104 writes the packet into a corresponding one of the queues 105b to 105d (step St7). Next, the reading control circuit 108 reads the packet from each of the queues 105b to 105d in an order of the priority of the packet in accordance with the store and forward system (step St8). In this way, the reception-side line IF unit 11a operates.

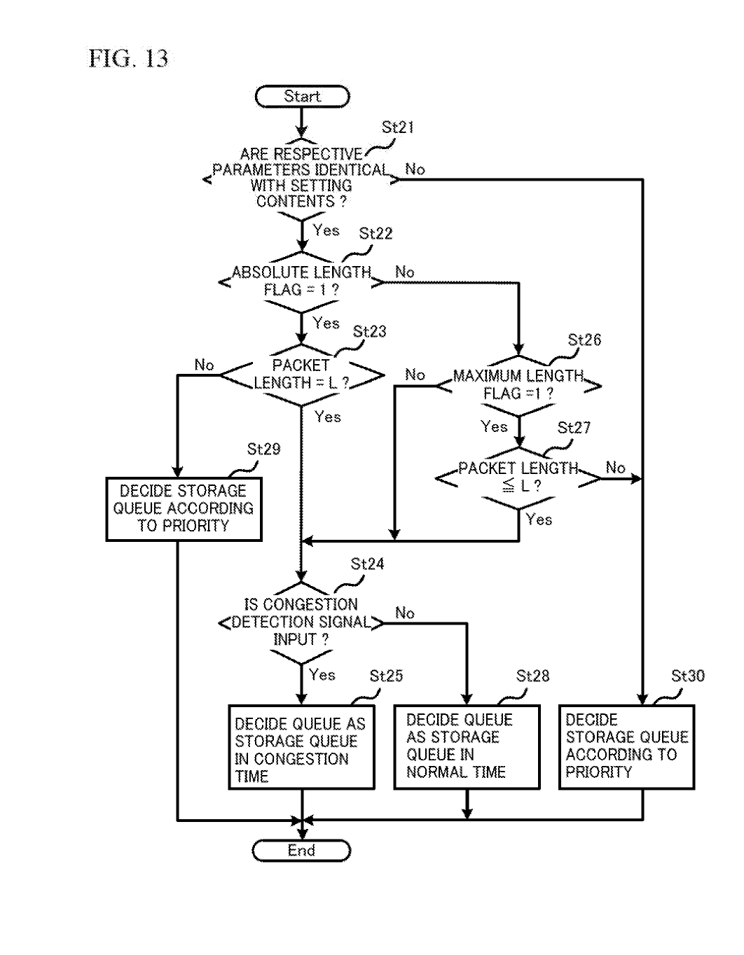

FIG. 13 is a flowchart illustrating an example of the determination processing of the storage queue. The filter processing part 102 determines whether respective parameters in the packet are identical with any one of pairs of the “MAC address”, the “IP address”, the “protocol type” and the “priority” registered into the filter table 103 (step St21). When at least one parameter is not identical with the above-mentioned setting contents (i.e., the “MAC address”, the “IP address”, the “protocol type” and the “priority”) (No in step St21), the queue deciding part 101 decides the storage queue from the queues 105b to 105d in accordance with the priority of the packet (i.e. identifies the storage queue based on the priority) (step St30).

Moreover, when the respective parameters in the packet are identical with the setting contents (Yes in step St21), the filter processing part 102 determines whether the corresponding “absolute length flag” in the filter table 103 is “1” (step St22). When the “absolute length flag” is “1” (Yes in step St22), the filter processing part 102 determines whether the packet length of the packet is identical with the corresponding “packet length” (L) in the filter table 103 (step St23).

When the packet length of the packet is not identical with the corresponding “packet length” (L) in the filter table 103 (No in step St23), the queue deciding part 101 decides the storage queue from the queues 105b to 105d in accordance with the priority of the packet (i.e. identifies the storage queue based on the priority) (step St29).

When the packet length of the packet is identical with the corresponding “packet length” (L) in the filter table 103 (Yes in step St23), the filter processing part 102 determines whether the congestion detection signal is input from the congestion state detecting part 106 with respect to any one of the queues 105b to 105d in the “storage queue (normal time)” (step St24). Here, when the “storage queue (normal time)” is set to the low delay queue 105a, the result of the determination of step S24 is “No”.

When the congestion detection signal is input (Yes in step St24), the queue deciding part 101 decides the queue indicated by the “storage queue (congestion time)” rather than the “storage queue (normal time)” in the filter table 103, as the storage queue (step St25). In the case of the setting example of FIG. 10, when the congestion detection signal of the high priority queue 105b is input, the low delay queue 105a is decided as the storage queue.

When the congestion detection signal is not input (No in step St24), the queue deciding part 101 decides the queue indicated by the “storage queue (normal time)” in the filter table 103, as the storage queue (step St28). In the case of the setting example of FIG. 10, when the congestion detection signal of the high priority queue 105b is not input, the high priority queue 105b is decided as the storage queue.

When the “absolute length flag” is “0” (No in step St22), the filter processing part 102 determines whether the corresponding “maximum length flag” in the filter table 103 is “1” (step St26). When the corresponding “maximum length flag” in the filter table 103 is “0” (No in step St26), the processing of step St24 is performed.

When the corresponding “maximum length flag” in the filter table 103 is “1” (Yes in step St26), the filter processing part 102 determines whether the packet length of the packet is equal to or less than the corresponding “packet length” (L) in the filter table 103 (step St27). When the packet length of the packet is equal to or less than the corresponding “packet length” (L) in the filter table 103 (Yes in step St27), the processing of step St24 is performed.

When the packet length of the packet is more than the corresponding “packet length” (L) in the filter table 103 (No in step St27), the queue deciding part 101 decides the storage queue from the queues 105b to 105d in accordance with the priority of the packet (i.e. identifies the storage queue based on the priority) (step St30). In this way, the determination processing of the storage queue is performed.

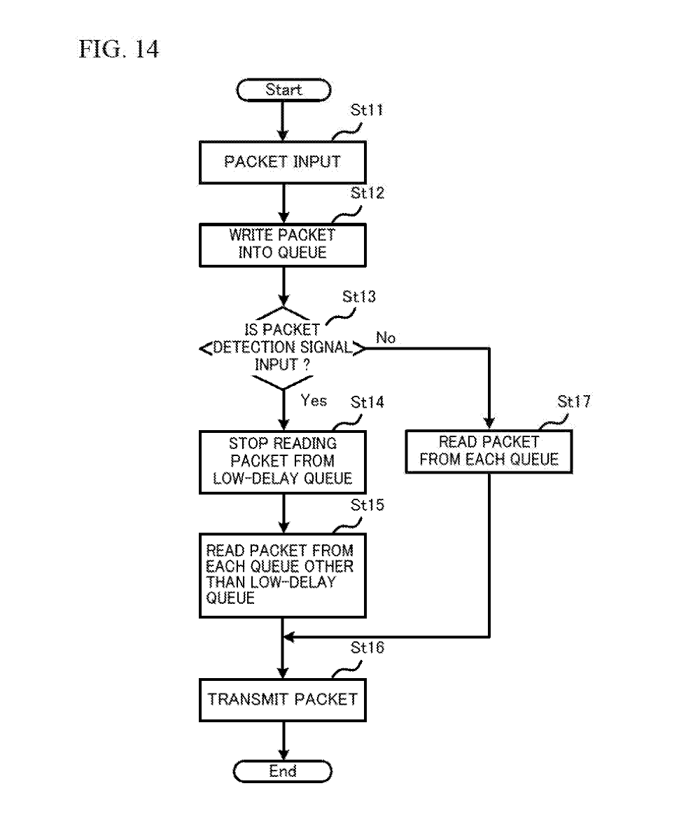

FIG. 14 is a flowchart illustrating an example of the operation of the transmission-side line IF unit 11b. First, the packet is input from the switch circuit 120 or 121 to the writing control circuit 110 or 111 (step St11). The switch circuit 120 or 121 writes the packet into a corresponding one of the queues 112a to 112d (step St12).

Next, the reading control circuit 113 determines whether the packet detection signal is input from the reception-side line IF unit 11a (step St13). When the packet detection signal is not input (No in step St13), the reading control circuit 113 reads the packet from each of the queues 112a to 112d and outputs the packet to the transmission port 114 (step St17). Next, the transmission port 114 transmits the packet input from the reading control circuit 113 to other device (step St16).

When the packet detection signal is input (Yes in step St13), the reading control circuit 113 stops reading the low delay packet from the low delay queue 112a (step St14). That is, the packet detection signal is input to the reading control circuit 113, so that the reading of the low delay packet from the low delay queue 112a is restricted.

Next, the reading control circuit 113 reads the packet from each of the queues 112a to 112d other than the low delay queue 112a, and outputs the packet to the transmission port 114 (step St15). Next, the transmission port 114 transmits the packet input from the reading control circuit 113 to other device (step St16). In this way, the transmission-side line IF unit 11b operates.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A packet transfer device comprising:
a first storage that stores a first priority packet;
a second storage that stores a second priority packet having a lower priority than the first priority packet;
a first reader that reads the first priority packet stored into the first storage before storing the first priority packet into the first storage is completed; and
a second reader that reads the second priority packet stored into the second storage after storing the second priority packet stored into the second storage is completed.

2. The packet transfer device as claimed in claim 1, further comprising:
a transmitter that transmits the first priority packet input from the first reader through a first route, and the second priority packet input from the second reader through a second route;
wherein the first route and the second route are provided independently of each other.

3. The packet transfer device as claimed in claim 2, further comprising:
an inputter that inputs the first priority packet to the first storage and inputs the second priority packet to the second storage;
a third storage that stores the first priority packet input from the first route;
a fourth storage that stores the second priority packet input from the second route; and
an outputter that reads the first priority packet from the third storage and outputs the first priority packet to the transmitter, and reads the second priority packet from the fourth storage and outputs the second priority packet to the transmitter;
wherein when inputting the first priority packet to the first storage, the inputter restricts the outputter from reading the second priority packet from the fourth storage.

4. The packet transfer device as claimed in claim 1, further comprising:
an identification circuit that identifies the first priority packet and the second priority packet from an input packet based on a packet length;
wherein the first priority packet and the second priority packet are input to the first storage and the second storage, respectively, according to an identification result of the identification circuit.

5. The packet transfer device as claimed in claim 4, wherein
when the packet length is equal to or less than a given value, the identification circuit identifies the input packet as the first priority packet, and
when the packet length is longer than the given value, the identification circuit identifies the input packet as the second priority packet.

6. The packet transfer device as claimed in claim 4, wherein
when the packet length is a given value, the identification circuit identifies the input packet as the first priority packet, and
when the packet length is not the given value, the identification circuit identifies the input packet as the second priority packet.

7. The packet transfer device as claimed in claim 1, further comprising:
a detector that detects congestion of the second priority packet in the second storage; and
an identification circuit that identifies the first priority packet and the second priority packet from an input packet according to a detection result of the detector;
wherein the first priority packet and the second priority packet are input to the first storage and the second storage, respectively, according to an identification result of the identification circuit.

8. A packet transfer method, implemented by a packet transfer device, of transferring a first priority packet and a second priority packet having a lower priority than the first priority packet, the method comprising:
reading the first priority packet stored into a first storage before storing the first priority packet into the first storage is completed; and
reading the second priority packet stored into a second storage after storing the second priority packet stored into the second storage is completed.

9. The packet transfer method as claimed in claim 8, further comprising:
transmitting the first priority packet read from the first storage and input through a first route, and the second priority packet read from the second storage and input through a second route;
wherein the first route and the second route are provided independently of each other.

10. The packet transfer method as claimed in claim 9, further comprising:
inputting the first priority packet to the first storage;
inputting the second priority packet to the second storage;
storing the first priority packet input from the first route into a third storage;
storing the second priority packet input from the second route into a fourth storage;
reading the first priority packet from the third storage and transmitting the first priority packet;
reading the second priority packet from the fourth storage and transmitting the second priority packet; and
restricting the reading of the second priority packet from the fourth storage when the first priority packet is input to the first storage.

11. The packet transfer method as claimed in claim 8, further comprising:
identifying the first priority packet and the second priority packet from an input packet based on a packet length; and
inputting the first priority packet and the second priority packet to the first storage and the second storage, respectively, according to an identification result of the identifying.

12. The packet transfer method as claimed in claim 11, wherein
when the packet length is equal to or less than a given value, the identifying identifies the input packet as the first priority packet, and
when the packet length is longer than the given value, the identifying identifies the input packet as the second priority packet.

13. The packet transfer method as claimed in claim 11, wherein
when the packet length is a given value, the identifying identifies the input packet as the first priority packet, and
when the packet length is not the given value, the identifying identifies the input packet as the second priority packet.

14. The packet transfer method as claimed in claim 8, further comprising:
detecting congestion of the second priority packet in the second storage;
identifying the first priority packet and the second priority packet from an input packet according to a detection result of the detecting; and
inputting the first priority packet and the second priority packet to the first storage and the second storage, respectively, according to an identification result of the identifying.
